(19) United States
(12) Patent Application Publication
(10) Pub. No.: US 2007/0077367 A1
(43) Pub. Date: Apr. 5, 2007

(54) Method for forming a pattern and liquid ejection apparatus

(75) Inventor: Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/541,938

(22) Filed: Oct. 2, 2006

(30) Foreign Application Priority Data
Oct. 4, 2005 (JP) 2005-291558

(51) Int. Cl. B05D 3/00; B05B 7/06; B05B 5/00

(52) U.S. Cl. 427/532; 427/256; 118/313; 118/642

(57) ABSTRACT

A nozzle surface capable of reflecting a laser beam is formed on a surface of a liquid ejection head opposed to a substrate. A reflection preventing film is provided on the nozzle surface. The laser beam reflected by a reflective surface and the nozzle surface is attenuated through interference between light reflected by a surface of the reflection preventing film and light reflected by the nozzle surface.

### CROSS-REFERENCE TO RELATED APPLICATIONS

This application is based upon and claims the benefit of priority from prior Japanese Patent Application No. 2005-291558, filed on Oct. 4, 2005, the entire contents of which are incorporated herein by reference.

### BACKGROUND

1. Technical Field

The present invention relates to a method for forming a pattern and a liquid ejection apparatus.

2. Related Art

Typically, a display such as a liquid crystal display or an electroluminescence display includes a substrate that displays an image. The substrate has an identification code (for example, a two-dimensional code) representing encoded information including the site of production and the product number. The identification code is formed by structures (dots formed by colored thin films or recesses) that reproduce the identification code. The structures are provided in multiple dot formation areas (data cells) in accordance with a prescribed pattern.

As a method for forming the identification code, a laser sputtering method and a waterjet method have been described in JP-A-11-77340 and JP-A-2003-127537. In the laser sputtering method, films forming a code pattern are provided through sputtering. The waterjet method involves ejection of water containing abrasive material onto a substrate for marking a code pattern on the substrate.

However, to form the code pattern in a predetermined size by the laser sputtering method, the interval between a metal foil and a substrate must be adjusted to several or several tens of micrometers. The corresponding surfaces of the substrate and the metal foil thus must be extremely flat and the interval between the substrate and the metal foil must be adjusted with accuracy of the order of micrometer. Therefore, the laser sputtering method is applicable only to certain types of substrates, making it difficult to form identification codes in a wider range of substrates. In the waterjet method, water or dust or abrasive may splash onto and contaminate a substrate, when forming a code pattern on the substrate.

To solve these problems, an inkjet method has been focused on as an alternative method for forming an identification code. In the inkjet method, droplets of liquid containing metal particles is ejected from a nozzle. The droplets are then dried and thus form dots. The inkjet method is applicable to a wider variety of substrates and prevents contamination of the substrates caused by formation of the identification codes.

However, when drying droplets on a substrate, the inkjet method may have the following problem caused by the surface condition of the substrate or the surface tension of each droplet. Specifically, after having been received by the surface of the substrate, the droplet may spread wet on the substrate surface as the time elapses. Therefore, if the time necessary for drying the droplet exceeds a predetermined level (for example, 100 milliseconds), the droplet may spread beyond the corresponding data cell and reaches an adjacent data cell. This may lead to erroneous formation of the code pattern.

This problem may be avoided by employing a method illustrated in FIG. 7. In the method, a laser beam L is radiated onto a substrate 102 located immediately below a liquid ejection head 101. After having been received by the substrate 102, a droplet Fb enters a zone of the laser beam L where the droplet Fb is quickly dried by the laser beam L. However, the method may cause multiple reflection of reflected light Lr or diffused light Ld, which have been reflected by the droplet Fb or the substrate 102, between a nozzle surface 103 and a surface 102a of the substrate 102. This may damage the nozzle surface 103, a nozzle N, other dots formed on the substrate 102, or other components of the apparatus.

### SUMMARY

Accordingly, it is an objective of the present invention to provide a method for forming dots and a liquid ejection apparatus that allow formation of a pattern with improved controllability while suppressing damages to components of the apparatus by laser beams.

To achieve the foregoing objective, one aspect of the present invention provides, a method for forming a pattern by ejecting droplets of a liquid containing a dot forming material from nozzles defined in a nozzle surface opposed to a surface of a substrate to the substrate and radiating a laser beam onto the droplets on the surface of the substrate. A reflection suppressing member formed on the nozzle surface receives the laser beam that has been reflected by the substrate, thereby suppressing reflection of the laser beam by the nozzle surface.

In accordance with another aspect of the present invention, a liquid ejection apparatus including a liquid ejection head that has a nozzle surface opposed to a surface of a substrate and ejects droplets of a liquid from nozzles defined in the nozzle surface to the substrate and a laser radiation device that radiates a laser beam onto the droplets on the surface of the substrate is provided. The apparatus includes a reflection suppressing member that is provided on the nozzle surface and suppresses reflection of the laser beam by the nozzle surface.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view showing a liquid crystal display having a pattern formed by a pattern forming method according to an embodiment of the present invention;

FIG. 2 is a perspective view schematically showing a liquid ejection apparatus;

FIG. 3 is a perspective view schematically showing a liquid ejection head and a laser head;

FIG. 4 is a cross-sectional view schematically showing the liquid ejection head and the laser head;

FIG. 5 is a block diagram representing an electric circuit of the liquid ejection apparatus;

FIG. 6 is a cross-sectional view schematically showing a liquid ejection head and a laser head according to a modification and

FIG. 7 is a cross-sectional view schematically showing a typical liquid ejection apparatus.

### DESCRIPTION OF EXEMPLARY EMBODIMENTS

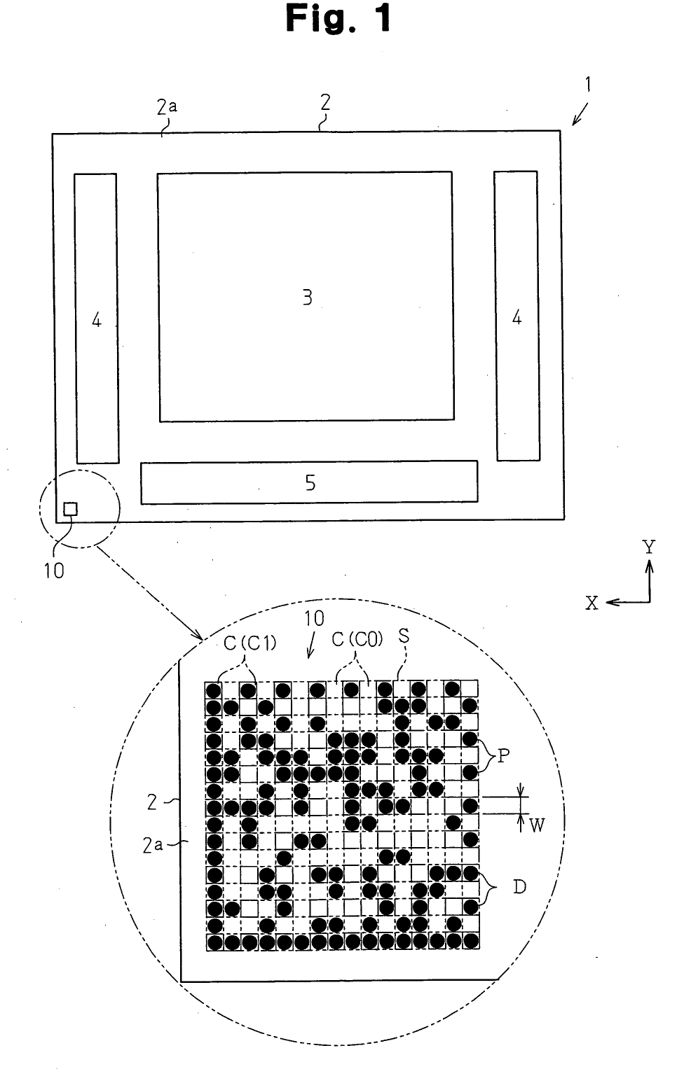

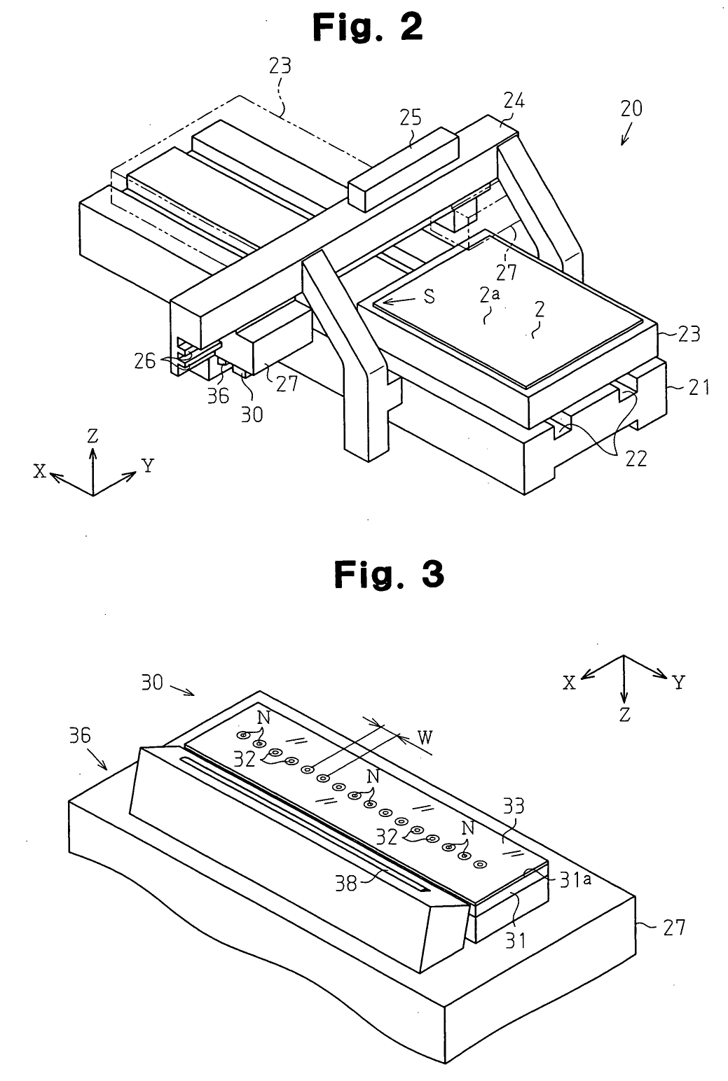

A liquid crystal display that has an identification code formed by a method for forming dots of the present invention will now be described with reference to FIGS. 1 to 5. In the description, direction X, direction Y, and direction Z are defined as illustrated in FIG. 2.

As shown in FIG. 1, a liquid crystal display 1 has a rectangular glass substrate (hereinafter, refereed to as a substrate) 2. A rectangular display portion 3 is formed substantially at the center of a surface 2a of the substrate 2. Liquid crystal molecules are sealed in the display portion 3. A scanning line driver circuit 4 and a data line driver circuit 5 are provided outside the display portion 3. In the liquid crystal display 1, the orientation of the liquid crystal molecules is adjusted in correspondence with a scanning signal generated by the scanning line driver circuit 4 and a data signal produced by the data line driver circuit 5. In accordance with the orientation of the liquid crystal molecules, area light radiated by an illumination device (not shown) is modulated to display an image on the display portion 3 of the substrate 2.

An identification code 10 indicating the product number or the lot number of the liquid crystal display 1 is formed at the left corner of the surface 2a of the substrate 2. The identification code 10 is formed by a plurality of dots D and provided in a code formation area S in accordance with a prescribed pattern. The code formation area S includes 256 data cells, aligned by 16 lines and 16 rows. Each of the data cells C is defined by virtually dividing the code formation area S, which has a square shape of 1 mm×1 mm, into equally sized sections. The dots D are formed in selected ones of the data cells C, thus forming the identification code 10. In the following, each of the cells C in which the dot D is provided is referred to as a black cell C1, or a dot forming position. Each of the empty cells C is referred to as a blank cell C0. The center of each black cell C1 is referred to as an “ejection target position P” and the length of each of the sides of the data cell C is referred to as “cell width W”.

Each of the dots D is formed by ejecting a droplet Fb of liquid containing metal particles (for example, nickel or manganese particles) into the corresponding one of the data cells C (the black cells C1). The droplet Fb is then dried and baked in the cell C, thus providing the dot D. Alternatively, the dot D may be completed simply by drying the droplet Fb in the cell C through radiation of a laser beam.

A liquid ejection apparatus 20 for forming the identification code 10 will hereafter be explained.

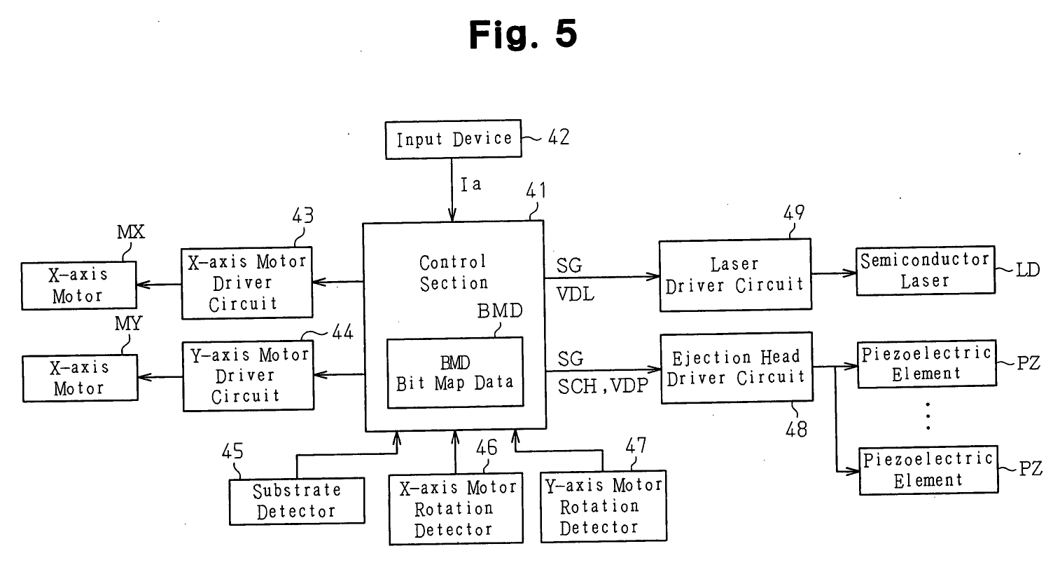

As shown in FIG. 2, the liquid ejection apparatus 20 has a parallelepiped base 21. A pair of guide grooves 22 are defined in the upper surface of the base 21 and extend in direction X. A substrate stage 23 is mounted on the base 21 and operably connected to an X-axis motor MX (see FIG. 5). When the X-axis motor MX runs, the substrate stage 23 moves in direction X or the direction opposite to direction X along the guide grooves 22. A suction type chuck mechanism (not shown) is provided on the upper surface of the substrate stage 23. The chuck mechanism operates to position and fix the substrate 2 on the substrate stage 23 at a predetermined position, with the surface 2a (the code formation area S) facing upward.

A gate-like guide member 24 is secured to opposing sides of the base 21. A reservoir tank 25 retaining liquid F is mounted on the guide member 24. A pair of guide rails 26 are provided in a lower portion of the guide member 24 and extend in direction Y. A carriage 27 is movably supported by the guide rails 26. The carriage 27 is operably connected to a Y-axis motor MY (see FIG. 5). The carriage 27 moves in direction Y or the direction opposite to direction Y along the guide rails 26. In the following, the position of the carriage 27 indicated by the solid lines of FIG. 2 is referred to as a first position. The position of the carriage 27 indicated by the double-dotted broken lines of FIG. 2 is referred to as a second position.

A liquid ejection head (hereinafter, referred to as an ejection head) 30 ejecting liquid is secured to the lower surface of the carriage 27. FIG. 3 is a perspective view showing the ejection head 30 as viewed from the side corresponding to the substrate 2. As illustrated in FIG. 3, the ejection head 30 includes a nozzle plate 31, a reflection member, formed on the surface (the top surface as viewed in FIG. 3) of the ejection head 30 opposed to the substrate 2. The nozzle plate 31 is formed by a plate member formed of stainless steel.

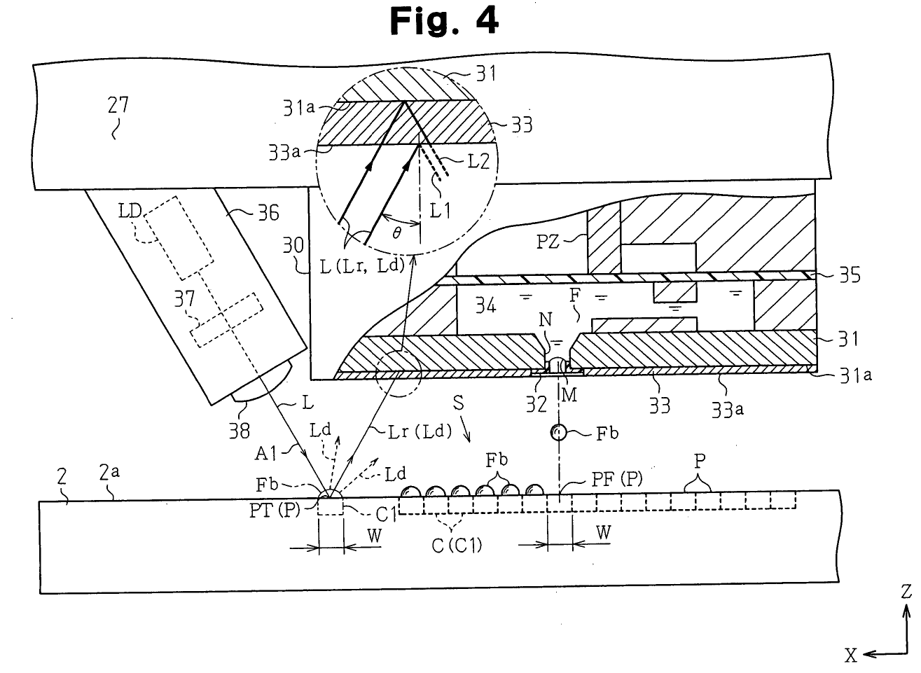

A plurality of nozzles N, or ejection ports, are defined in the nozzle plate 31 and spaced at equal intervals along direction Y. The pitch of the nozzles N is set to a value equal to the pitch of the ejection target positions P (the cell width W of FIG. 1). As illustrated in FIG. 4, a surface (hereinafter, referred to as a reflective surface) 31a of the nozzle plate 31 opposed to the substrate 2 is formed through mirror-surface machining in such a manner that a laser beam L is reflected by the reflective surface 31a. The reflective surface 31a of the nozzle plate 31 extends parallel with the surface 2a of the substrate 2. Each of the nozzles N extends in a direction perpendicular to the substrate 2 and through the nozzle plate 31. In the following, the position of the substrate 2 opposed to each of the nozzles N is referred to as a “droplet receiving position PF”.

A liquid repellent film 32 with thickness of several hundreds of nanometers is provided along the inner wall surface of each nozzle N in the vicinity of the nozzle surface 31a. The liquid repellent film 32 is a film that is transmissible to the laser beams L. The liquid repellent film 32 is formed of a silicone resin or a fluorine resin and thus repels the liquid F. That is, the liquid repellent film 32 stabilizes the position of the interface (the meniscus M) of the liquid F in each of the nozzles N. Although the liquid repellent film 32 of the illustrated embodiment is formed directly on the nozzle plate 31, an adhesion layer with thickness of several nanometers formed by a silane coupling agent may be arranged between the nozzle plate 31 and the liquid repellent film 32. This promotes bonding between the nozzle plate 31 and the liquid repellent film 32.

A reflection suppressing member, which is a reflection preventing film 33, is formed in the entire portion of the nozzle surface 31a except for the portions corresponding to the liquid repellent films 32. The reflection preventing film 33 is formed of inorganic material such as silicon oxide, silicon nitride, silicon oxynitride, or indium tin oxide (ITO). In correspondence with the thickness and the refraction index of the reflection preventing film 33, the phase and the amplitude of the laser beam L reflected by the nozzle surface 31a (the reflected light L2) are adjusted. The reflection preventing film 33 attenuates the laser beam L through interference between the laser beam L reflected by the surface (the reflective surface 33a) of the reflection preventing film 33 (the reflected light L1) and the laser beam L reflected by the nozzle surface 31a (the reflected light L2).

Cavities 34 are defined in the ejection head 30 and communicate with the reservoir tank 25. The liquid F in the reservoir tank 25 is supplied to the nozzles N through the corresponding cavities 34. An oscillation plate 35, which oscillates in an upward-downward direction, is provided above each of the cavities 34 in the ejection head 30. Through oscillation of each oscillation plate 35, the volume of the corresponding cavity 34 is increased or decreased. A plurality of piezoelectric elements PZ are arranged on the oscillation plates 35 at positions corresponding to the nozzles N. When any one of the piezoelectric elements PZ repeatedly contracts and extends in an upward-downward direction, the corresponding one of the oscillation plates 35 oscillates in the upward-downward direction.

Specifically, when the substrate stage 23 is transported in direction X and an ejection target position P coincides with the corresponding receiving position PF, the corresponding piezoelectric element PZ contracts and extends. This increases and decreases the volume of the associated cavity 34, thus causing oscillation in the meniscus M. A predetermined amount of liquid F is thus ejected from the corresponding nozzle N as a droplet Fb. The droplet Fb then reaches the ejection target position P (the receiving position PF) on the substrate 2, which is arranged immediately below the nozzle N.

After having reached the ejection target position P, the droplet Fb spreads wet as the time elapses and enlarges to the dry size (the cell width W). In the following, the position (indicated by the double-dotted broken lines of FIG. 4) corresponding to the center of the droplet Fb when the outer diameter of the droplet Fb is equal to the cell width W will be referred to as a “radiating position PT”. The radiating position PT is set in an area opposing the nozzle plate 31.

As shown in FIG. 4, a laser head 36, or a laser radiation device, is arranged in the vicinity of the ejection head 30. The laser head 36 includes semiconductor lasers LD. The laser beam L radiated by each of the semiconductor lasers LD has a wavelength range corresponding to the absorption range of the liquid F (including dispersion medium and metal particles). Each semiconductor laser LD has an optical system including a collimator 37 and a cylindrical lens 38. The collimator 37 causes the laser beam L of the associated semiconductor laser LD to converge into a parallel light flux and guides the flux to the cylindrical lens 38. The cylindrical lens 38 causes the laser beam L sent from the collimator 37 to converge onto the surface 2a of the substrate 2. This forms an elongated beam spot extending in direction Y on the surface 2a of the substrate 2. The optical axis A1 of each optical system is inclined with respect to a normal line of the surface 2a of the substrate 2 and passes through a radiating position PT.

With the beam spot formed by the laser beam L of the semiconductor laser LD on the surface 2a of the substrate 2, the substrate 2 is transported in direction X. The droplet Fb reaches the radiating position PT when the outer diameter of the droplet Fb is equal to the cell width W. While passing the radiating position PT, the droplet Fb is irradiated by the laser beam L from the laser head 36. This evaporates the dispersion medium from the droplet Fb, suppressing wet spreading of the droplet Fb. Meanwhile, the metal particles in the droplet Fb are baked through continuous radiation of the laser beam L. As a result, a semispherical dot D having an outer diameter equal to the cell width W is formed on the surface 2a of the substrate 2.

The laser beam L radiated onto the radiating position PT is reflected by the surface 2a of the substrate 2 and the droplet Fb, generating reflected light Lr and diffused light Ld. However, the reflection preventing film 33 causes the reflected light Lr and the diffused light Ld to cancel each other, greatly attenuating the reflected light Lr and the diffused light Ld. In other words, the laser beam L is attenuated through reflection by the reflective surface 33a and the nozzle surface 31a. This suppresses multiple reflection of the laser beam L between the substrate 2 and the nozzle plate 31. The laser beam L is thus prevented from being radiated onto positions other than the radiating position PT. Accordingly, damages to various components (including the liquid repellent film 32, the nozzles N, the nozzle plate 31) by the laser beam L are avoided.

The electric circuit of the liquid ejection apparatus 20 will hereafter be explained with reference to FIG. 5.

As illustrated in FIG. 5, a control section 41 has a CPU, a RAM, and a ROM. The control section 41 controls movement of the substrate stage 23 and operation of the ejection head 30 and the laser head 36 in correspondence with various types of data and different control programs stored in the ROM.

An input device 42 including different manipulation switches is connected to the control section 41. The control section 41 receives operation signals and imaging data Ia representing an image of the identification code 10 from the input device 42. The control section 41 performs a prescribed development process on the imaging data Ia. Further, the control section 41 generates bit map data BMD indicating selected ones of the data cells C of the code formation area S onto which droplets Fb are to be ejected. The bit map data BMD is stored in the RAM.

An X-axis motor driver circuit 43 and a Y-axis motor driver circuit 44 are connected to the control section 41. The control section 41 sends a control signal to the X-axis motor driver circuit 43 for actuating the X-axis motor MX. The control section 41 sends a control signal to the Y-axis motor driver circuit 44 for actuating the Y-axis motor MY. In response to the control signal of the control section 41, the X-axis motor driver circuit 43 operates to rotate the X-axis motor MX in a forward or reverse direction, thus reciprocating the substrate stage 23. In response to the control signal of the control section 41, the Y-axis motor driver circuit 44 operates to rotate the Y-axis motor MY in a forward or reverse direction, thus reciprocating the carriage 27.

A substrate detector 45 is connected to the control section 41. The substrate detector 45 is capable of detecting an end of the substrate 2. In correspondence with a detection signal sent from the substrate detector 45, the control section 41 calculates the position of the substrate 2.

An X-axis motor rotation detector 46 and a Y-axis motor rotation detector 47 are connected to the control section 41. The X-axis motor rotation detector 46 and the Y-axis motor rotation detector 47 send detection signals to the control section 41. In correspondence with a detection signal of the X-axis motor rotation detector 46, the control section 41 calculates the movement direction and the movement amount of the substrate 2. When the center of one of the data cells C coincides with the receiving position PF, the control section 41 provides an ejection timing signal SG to the ejection head driver circuit 48 and the laser driver circuit 49. In correspondence with a detection signal of the Y-axis motor rotation detector 47, the control section 41 calculates the movement direction and the movement amount of the ejection head 30. As a result, the receiving position PF corresponding to the associated nozzle N is located on the movement path of the ejection target position PF.

The ejection head driver circuit 48 is connected to the control section 41. The control section 41 sends the ejection timing signal SG and piezoelectric element drive voltage VDP, which is synchronized with a prescribed clock signal, to the ejection head driver circuit 48. The control section 41 generates the bit map data BMD (a head control signal SCH), which is synchronized with a prescribed clock signal. The bit map data BMD is transferred to the ejection head driver circuit 48. The ejection head driver circuit 48 performs serial-parallel conversion on the head control signal SCH of the control section 41 in correspondence with the piezoelectric elements PZ. In response to the ejection timing signal SG of the control section 41, the ejection head driver circuit 48 supplies the piezoelectric element drive voltage VDP to the piezoelectric element PZ corresponding to the head control signal SCH.

The laser driver circuit 49 is connected to the control section 41. The control section 41 provides the ejection timing signal SG and laser drive voltage VDL, which is synchronized with a prescribed clock signal, to the laser driver circuit 49. In response to the ejection timing signal SG of the control section 41, the laser driver circuit 49 supplies the laser drive voltage VDL to the corresponding semiconductor laser LD.

A method for forming the identification code 10 using the liquid ejection apparatus 20 will hereafter be explained.

First, as illustrated in FIG. 2, the substrate 2 is fixed to the substrate stage 23 with the surface 2a facing upward. In this state, the substrate 2 is located rearward from the guide member 24 in direction X.

Subsequently, the imaging data Ia is input to the control section 41 through manipulation of the input device 42. The control section 41 then produces the bit map data BMD based on the imaging data Ia. Further, the control section 41 generates the piezoelectric element drive voltage VDP and the laser drive voltage VDL, which drive the piezoelectric elements PZ and the semiconductor lasers LD, respectively.

The control section 41 then actuates the Y-axis motor MY to transport the carriage 27 (the nozzles N) from the first position in direction Y in such a manner that each of the ejection target positions P passes the corresponding one of the receiving positions PF.

Once the carriage 27 is set at a predetermined position, the control section 41 actuates the X-axis motor MX to move the substrate stage 23 in direction X, thus transporting the substrate 2. The control section 41 determines whether the black cells C1 (the ejection target positions P) have reached the corresponding receiving positions PF in correspondence with detection signals sent from the substrate detector 45 and the X-axis motor rotation detector 46. When the black cells C1 move to the receiving positions PF, the control section 41 outputs the piezoelectric element drive voltage VDP and the head control signal SCH to the ejection head driver circuit 48. The control section 41 also supplies the laser drive voltage VDL to the laser driver circuit 49. The control section 41 then stands by until the control section 41 must output the ejection timing signals SG to both of the ejection head driver circuit 48 and the laser driver circuit 49.

When the black cells C1 (the ejection target positions P) of the first row reach the corresponding receiving positions PF, the control section 41 sends the ejection timing signals SG to the ejection head driver circuit 48 and the laser driver circuit 49.

After having sent the ejection timing signals SG, the control section 41 supplies the piezoelectric element drive voltage VDP to the piezoelectric elements PZ corresponding to the head control signal SCH through the ejection head driver circuit 48. This causes the nozzles N corresponding to the head control signal SCH to eject the droplets Fb simultaneously. The droplets Fb then reach the corresponding receiving positions PF (ejection target positions P) on the substrate 2.

At this stage, the control section 41 supplies the laser drive voltage VDL to the corresponding semiconductor lasers LD through the laser driver circuit 49. The semiconductor lasers LD thus radiate the laser beams L, which form the beam spots at the corresponding receiving positions PT on the substrate 2.

In this state, as illustrated in FIG. 4, each of the laser beams L is partially reflected by the surface 2a of the substrate 2 toward the ejection head 30 (the nozzle plate 31). However, the reflection preventing film 33 causes mutual interference of the reflected lights Lr and attenuates the reflected lights Lr greatly. The reflected lights Lr is thus terminated at the nozzle plate 31. In other words, the laser beams L reflected by the reflective surface 33a and the nozzle surface 31a are continuously attenuated while the droplets Fb are moving toward the beam spots at the radiating positions PT. The laser beams L are thus radiated solely onto the corresponding radiating positions PT on the substrate 2.

After each of the droplets Fb has been received by the substrate 2, the outer diameter of the droplet Fb increases to the cell width W by the time the droplet Fb reaches the corresponding radiating position PT (the beam spot). At the radiating position PT, the laser beam L is radiated onto the droplet Fb, evaporating the dispersion medium from the droplet Fb and baking the metal particles of the droplet Fb. Accordingly, the dot D is formed in the corresponding cell C (the black cell C1).

The laser beam L is partially reflected and diffused by the droplet Fb toward the ejection head 30 (the nozzle plate 31). However, the reflection preventing film 33 causes interference between the reflected light Lr and the diffused light Ld, greatly attenuating the reflected light Lr and the diffused light Ld. The reflected light Lr and the diffused light Ld are thus terminated at the nozzle plate 31. That is, while the droplet Fb is being dried and baked, the laser beam L reflected by the reflective surface 33a and the nozzle surface 31a is continuously attenuated. The laser beam L is thus radiated onto the droplet Fb only at the radiating position PT.

Afterwards, each time the target ejection positions P reach the corresponding receiving positions PF, the control section 41 operates to simultaneously eject the droplets Fb from the corresponding nozzles N in the above-described manner. When the outer diameter of each droplet Fb is equal to the cell width W, the laser head 36 is caused to simultaneously radiate the laser beams L onto the droplets Fb. In this manner, the dots D are formed in the code formation area S in accordance with a prescribed pattern, thus providing the identification code 10.

The illustrated embodiment has the following advantages.

(1) The nozzle surface 31a, which reflects the laser beams L, is formed on the surface of the ejection head 30 opposed to the substrate 2. Further, the reflection preventing film 33 is provided on the surface of the nozzle surface 31a opposed to the substrate 2. The reflected light L1 reflected by the reflective surface 33a of the reflection preventing film 33 and the reflected light L2 reflected by the nozzle surface 31a of the nozzle plate 31 interfere with each other. This attenuates the laser light L reflected by the reflective surface 33a and the nozzle surface 31a.

Thus, even though the laser beams L are reflected or diffused by the substrate 2 or the droplets Fb, the laser beams L are terminated at the nozzle surface 31a (the ejection head 30). This suppresses multiple reflections of the laser beams L between the substrate 2 and the ejection head 30. The laser beams L are thus radiated solely onto the radiating positions PT. Accordingly, while suppressing damages to the components by the laser beams L, the dots D with the outer diameter equal to the cell width W can be provided. This improves controllability in the formation of the pattern.

(2) Since the thickness of the reflection preventing film 33 is relatively small, the interval between the nozzle surface 31a and the surface 2a of the substrate 2 (platen gap) is maintained maximally. Therefore, damages to the components by the laser beams L are suppressed without decreasing the accuracy for ejecting the droplets Fb onto the receiving positions.

(3) The reflection preventing film 33 is formed in the entire portion of the nozzle surface 31a except for the portions corresponding to the liquid repellent films 32. Therefore, the material and the thickness of the reflection preventing film 33 are selected without being limited by factors involved in ejection of the droplets Fb.

The illustrated embodiment may be modified in the following manners.

In the illustrated embodiment, a multiple-layered film having a plurality of films having a certain attenuation coefficient, a light absorbing thin film (for example, a thin film containing pigments absorbing the laser beams L), or a porous thin film (for example, a thin film formed of silicon resin containing silica nanoparticles) may be employed as the reflection preventing film 33. In these cases, the laser beams L are continuously absorbed by the reflection preventing film 33. This enlarges the range of the incident angle θ (see FIG. 4) or the wavelength of the laser beams L that can be prevented from being reflected.

Alternatively, the laser beams L absorbed by the reflection preventing film 33 may be converted into heat. The heat escapes to the exterior through the nozzle plate 31 formed of stainless steel, a component defining the cavity formed of Si, or the liquid F in the vicinity of each nozzle N. Further, the viscosity of the liquid F, which is relatively high, may be lowered in correspondence with the conversion amount of the heat. In this case, ejection of the liquid F becomes stable.

In the illustrated embodiment, the reflection preventing film 33 may be formed by a single layer film or a multiple layer film containing organic material that repels the liquid F (for example, a metal film containing fluorine resin or particles of the fluorine resin). This prevents contamination of the interior of the apparatus by the liquid F, stabilizing the optical properties of the apparatus.

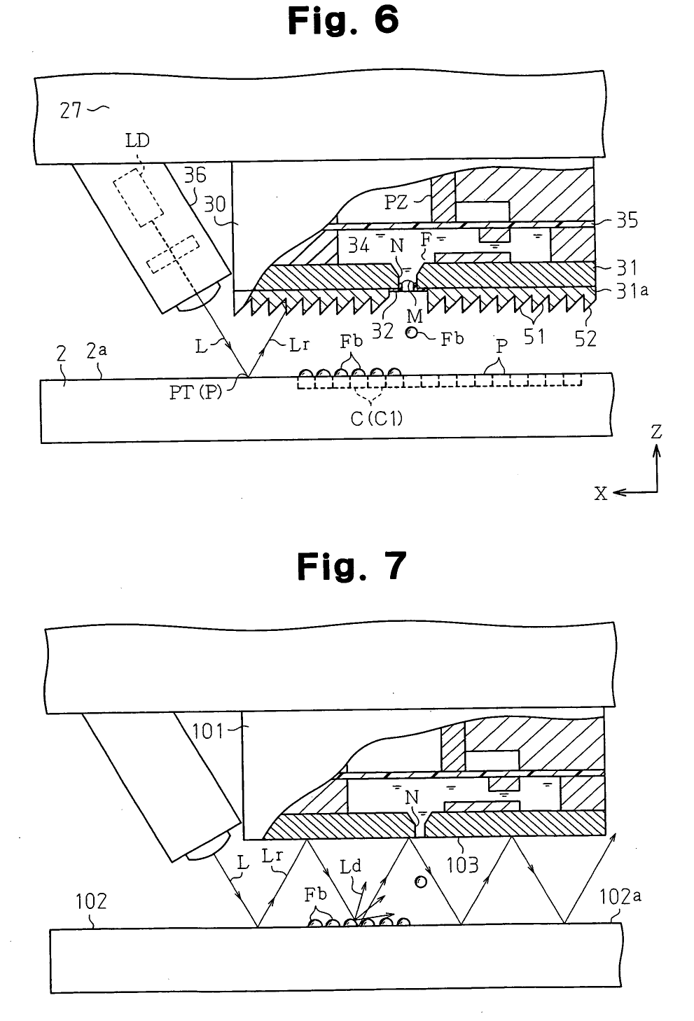

Referring to FIG. 6, a reflection preventing plate 52 including a plurality of recesses 51, each of which has a triangular cross-sectional shape, may be employed as a reflection suppressing member. The reflection preventing plate 52 absorbs the laser beams L that have been reflected by the substrate 2. Further, the reflection preventing plate 52 may be mechanically or magnetically attachable to and detachable from the nozzle surface 31a. This facilitates cleansing of the nozzles N or the nozzle surface 31a, thus stabilizing ejection of the droplets Fb.

In the illustrated embodiment, the liquid repellent films 32 may be provided in such a manner as to cover not only the vicinities of the nozzles N but the entire reflection preventing film 33.

In the illustrated embodiment, instead of the elongated beam spots, circular or oval beam spots may be formed on the surface 2a of the substrate 2.

In the illustrated embodiment, the droplets Fb may be caused to flow in a desired direction using energy generated by the laser beams L. Alternatively, by radiating the laser beam only to the outer peripheral end of each droplet Fb, the surface of the droplet Fb may be solidified (pinned) exclusively. In other words, the present invention may be applied to any other suitable method by which dots are formed through radiation of the laser beams L onto the droplets Fb.

In the illustrated embodiment, the laser beams L may be reflected by the backside of the substrate 2 or the substrate stage 23. That is, reflection of the laser beams L may be caused in any suitable manner as long as such reflection occurs at the side corresponding to the substrate 2 and opposed to the ejection head 30.

In the illustrated embodiment, a carbon dioxide gas laser or a YAG laser may be used as a laser radiation source. That is, any suitable laser radiation source may be employed as long as the wavelength of the radiated laser beam L causes drying of the droplet Fb.

In the illustrated embodiment, instead of the semispherical dots D, the droplets Fb may form oval dots or linear structures.

The present invention may be applied to a method for forming a pattern of an insulating film or metal wiring of a field effect type device (FED or SED). The field effect type device emits light from a fluorescent substance using electrons released from a flat electron release element. In other words, the present invention may be applied to any other suitable method for forming patterns by radiating laser beams L onto droplets Fb.

In the illustrated embodiment, the substrate 2 may be, for example, a silicone substrate, a flexible substrate, or a metal substrate.

1. A method for forming a pattern by ejecting droplets of a liquid containing a dot forming material from nozzles defined in a nozzle surface opposed to a surface of a substrate to the substrate and radiating a laser beam onto the droplets on the surface of the substrate, wherein a reflection suppressing member formed on the nozzle surface receives the laser beam that has been reflected by the substrate, thereby suppressing reflection of the laser beam by the nozzle surface.

2. The method according to claim 1, wherein the reflection of the laser beam by the nozzle surface is suppressed through interference between the laser beam reflected by a surface of the reflection suppressing member and the laser beam reflected by the nozzle surface.

3. The method according to claim 1, wherein the reflection suppressing member is formed by a reflection preventing film formed on the nozzle surface.

4. The method according to claim 1, wherein the reflection suppressing member is formed of silicon oxide, silicon nitride, silicon oxynitride, or indium tin oxide.

5. A liquid ejection apparatus including a liquid ejection head that has a nozzle surface opposed to a surface of a substrate and ejects droplets of a liquid from nozzles defined in the nozzle surface to the substrate and a laser radiation device that radiates a laser beam onto the droplets on the surface of the substrate, the apparatus comprising:
a reflection suppressing member that is provided on the nozzle surface and suppresses reflection of the laser beam by the nozzle surface.

6. The apparatus according to claim 5, wherein the reflection suppressing member is formed by a reflection preventing film formed on the nozzle surface.

7. The apparatus according to claim 5, wherein the reflection suppressing member has a property of absorbing the laser beam.

8. The apparatus according to claim 5, wherein the reflection suppressing member is provided in the portions of the nozzle surface other than the portions corresponding to the nozzles.

9. The apparatus according to claim 5, wherein the reflection suppressing member has a liquid repellent property with respect to the droplets.

10. The apparatus according to claim 5, wherein the reflection suppressing member suppresses the reflection of the laser beam by the nozzle surface through interference between the laser beam that has been reflected by a surface of the reflection suppressing member and the laser beam that has been reflected by the nozzle surface.

11. The apparatus according to claim 5, wherein the reflection suppressing member is formed of silicon oxide, silicon nitride, silicon oxynitride, or indium tin oxide.

12. The apparatus according to claim 5, wherein the nozzle surface is arranged parallel with the surface of the substrate.

13. The apparatus according to claim 5, wherein an inner wall surface of each nozzle is covered by a liquid repellent film that has a liquid repellent property with respect to the droplets.

14. The apparatus according to claim 13, wherein the liquid repellent film is formed of a silicone resin or a fluorine resin.

15. The apparatus according to claim 5, wherein the reflection suppressing member is formed by a plate having a plurality of recesses defined in a surface of the plate.

16. The apparatus according to claim 5, wherein the reflection suppressing member is attachable to and detachable from the nozzle surface.
